(19) United States
(12) Patent Application Publication
(10) Pub. No.: US 2026/0357768 A1
(43) Pub. Date: Nov. 12, 2026

(54) SINGLE COMBUSTION OUTBOARD TURBINE ROCKET CYCLE

(71) Applicant: Aubrey James McKelvy, Weston, MA (US)

(72) Inventor: Aubrey James McKelvy, Weston, MA (US)

(21) Appl. No.: 19/636,620

(22) Filed: Apr. 1, 2026

Related U.S. Application Data
(60) Provisional application No. 63/801,486, filed on May 7, 2025.

(51) Int. Cl. F02K 9/64; F02K 9/46; F02K 9/48; F02K 9/52; F02K 9/60; F02K 9/97

(52) U.S. Cl. CPC F02K 9/64; F02K 9/46; F02K 9/48; F02K 9/52; F02K 9/605; F02K 9/972

(57) ABSTRACT

A single combustion outboard turbine rocket engine and cycle is provided. The rocket engine and cycle can use exhaust from a rocket-engine nozzle, rather than exhaust from one or more pre-burners to motivate a fuel pump and/or an oxidizer pump. The rocket engine and cycle can simplify the configuration and operation of the rocket engine and cycle in comparison to conventional rocket engines and cycles.

The present application claims the benefit of U.S. Provisional Application No. 63/801,486, filed May 7, 2025, which is hereby incorporated by reference in its entirety.

### FIELD

A single combustion outboard turbine rocket engine and cycle can use exhaust from a rocket-engine nozzle, rather than exhaust from one or more pre-burners to motivate a fuel pump and/or an oxidizer pump, and can eliminate the need to pipe the exhaust from one or more pre-burners to drive the fuel pump and/or the oxidizer pump to simplify the configuration and operation of the rocket engine and cycle in comparison to conventional rocket engines and cycles.

### BACKGROUND

Conventional staged combustion engines and cycles use one or more pre-burner chambers to drive operation of a fuel pump and/or an oxidizer pump. In the pre-burner chambers, fuel from a fuel supply tank and oxidizer from an oxidizer supply tank are combined and burned, and the exhaust is used to drive one or more pump turbines that correspondingly motivate the fuel pump and the oxidizer pump.

To illustrate briefly, in a fuel-rich staged closed combustion engine and cycle, a relatively small amount of the oxidizer from the oxidizer supply tank is combined with full flow of the fuel from the fuel supply tank in a pre-burner. The resulting exhaust from the pre-burner chamber is fuel-rich and drives a pump turbine used to motivate the fuel pump and the oxidizer pump. Ultimately, the fuel-rich exhaust from the pre-burner and most of the oxidizer from the oxidizer supply tank are fed to the primary combustion chamber of the fuel-rich staged closed combustion engine.

In an oxidizer-rich staged closed combustion engine and cycle, a relatively small amount of the fuel from the fuel supply tank is combined with full flow from the oxidizer supply tank in a pre-burner. The resulting exhaust from the pre-burner chamber is oxidizer-rich and drives a pump turbine used to motivate the fuel pump and the oxidizer pump. Ultimately, the oxidizer-rich exhaust from the pre-burner and most of the fuel from the fuel supply tank are fed to the primary combustion chamber of the oxidizer-rich staged closed combustion engine.

In an open-cycle staged combustion cycle, relatively small amounts of the fuel from the fuel supply tank and oxidizer from the oxidizer supply tank are combined in a pre-burner. The resulting exhaust from the pre-burner chamber drives a pump turbine used to motivate the fuel pump and the oxidizer pump. Ultimately, the exhaust from the pre-burner is expelled from the system, and most of the fuel from the fuel supply tank and the oxidizer from the oxidizer supply tank are fed to the primary combustion chamber of the open-cycle staged combustion engine.

In a full-flow staged combustion cycle, a relatively small amount of oxidizer from the oxidizer supply tank and most of the fuel from the fuel supply tank are combined in a first pre-burner, and a relative small amount of fuel from the fuel supply tank and most of the oxidizer from the oxidizer supply tank is combined in a second pre-burner. Exhaust from the first pre-burner is used to drive a first turbine that motivates the fuel pump, and exhaust from the second pre-burner is used to drive a second turbine that motivates the oxidizer pump. Ultimately, the fuel-rich exhaust from the first pre-burner and the oxidizer-rich exhaust from the second pre-burner are fed to the primary combustion chamber of the full-flow staged combustion cycle.

While there are other rocket engines and cycles, those described above are typical representations of rocket cycles and engines that have been commonly used. However, each of these typical rocket cycles and engines have significant similar limitations. To illustrate, piping the fuel and the oxidizer to the one or more pre-burners, and also piping the exhaust from the one or more pre-burners to the turbines motivating the fuel pump and/or the oxidizer pump can be complicated. The piping needs to handle both extreme pressures and extreme temperatures of the fuel and the oxidizer from the corresponding supply tanks and the exhaust from the pre-burners. The piping of the exhaust can be especially difficult. And controlling the supply of the fuel and the oxidizer through the piping requires use of valving that must also be robust enough to handle the extreme pressures and the extreme temperatures thereof, and likewise, the turbines driven by the exhaust from the one or more pre-burners also must be robust enough to handle the extreme pressures and the extreme temperatures thereof. Designing and managing these rocket engines and cycles taking into account the extreme pressures and the extreme temperatures of the fuel, the oxidizer, and the exhaust from the one or more pre-burners can be challenging. Furthermore, the use of one or more pre-burners, and the required piping and valving therefor correspondingly increase the weight of these rocket engines. And the use of the one or more pre-burners can also make reconditioning of such rocket engines difficult, and correspondingly make reuse of the engines expensive, if not cost prohibitive.

Therefore, there is a need for a new rocket engine and cycle that limits the deleterious effects of the extreme pressures and the extreme temperatures, while also potentially reducing the weight of the engine and decreasing the cost of reuse. The rocket engine and cycle can use exhaust from a rocket-engine nozzle, rather than exhaust from the one or more pre-burners to motivate a fuel pump and/or an oxidizer pump, and can eliminate the need to pipe the exhaust from one or more pre-burners to drive the fuel pump and/or the oxidizer pump.

### SUMMARY

The techniques of this disclosure generally relate to embodiments of a single combustion outboard turbine rocket engine.

In one aspect, the present disclosure contemplates a method of operating a single combustion outboard turbine rocket engine, the method including supplying a combustion chamber with a first amount of fuel from a fuel tank and a first amount of oxidizer from an oxidizer tank; combusting the first amount of the fuel and the first amount of the oxidizer in the combustion chamber to generate exhaust; expelling the exhaust from the combustion chamber and into an engine nozzle; expelling the exhaust from the engine nozzle via an exit aperture; contacting the exhaust expelled from the engine nozzle with a plurality of turbine blades provided on a turbine shaft downstream of the exit aperture; driving rotation of the turbine shaft via interactions of the exhaust with the plurality of turbine blades actuating a fuel pump and an oxidizer pump via a transmission driven by the rotation of the turbine shaft; pumping a second amount of the fuel from the fuel tank via actuation of the fuel pump, and further supplying the combustion chamber with the fuel; and pumping a second amount of the oxidizer from the oxidizer tank via actuation of the oxidizer pump, and further supplying the combustion chamber with the oxidizer.

In another aspect, the present disclosure contemplates a method of operating a single combustion outboard turbine rocket engine, the method including supplying a combustion chamber with a first amount of fuel from a fuel tank and a first amount of oxidizer from an oxidizer tank; combusting the first amount of the fuel and the first amount of the oxidizer in the combustion chamber to generate exhaust; expelling the exhaust from the combustion chamber and into an engine nozzle; expelling the exhaust from the engine nozzle via an exit aperture; contacting the exhaust expelled from the engine nozzle with a plurality of turbine blades provided on a turbine shaft downstream of the exit aperture; rotatably supporting the turbine shaft relative to the combustion chamber and the engine nozzle; driving rotation of the turbine shaft via interactions of the exhaust with the plurality of turbine blades; rotating gearing of a transmission via rotation of the turbine shaft; driving rotation of a fuel-pump drive shaft and an oxidizer-pump drive shaft operatively interconnected with the ring gear via the gearing of the transmission to actuate a fuel pump and an oxidizer pump, respectively; pumping a second amount of the fuel from the fuel tank via actuation of the fuel pump, and further supplying the combustion chamber with the fuel; and pumping a second amount of the oxidizer from the oxidizer tank via actuation of the oxidizer pump, and further supplying the combustion chamber with the oxidizer.

In yet another aspect, the present disclosure contemplates a method of operating a single combustion outboard turbine rocket engine, the method including supplying a combustion chamber with a first amount of fuel from a fuel tank and a first amount of oxidizer from an oxidizer tank; combusting the first amount of the fuel and the first amount of the oxidizer in the combustion chamber to generate exhaust; expelling the exhaust from the combustion chamber and into an engine nozzle; expelling the exhaust from the engine nozzle via an exit aperture; contacting the exhaust expelled from the engine nozzle with a plurality of turbine blades provided on a turbine shaft downstream of the exist aperture; rotatably supporting the turbine shaft relative to the combustion chamber and the engine nozzle; driving rotation of the turbine shaft via interactions of the exhaust with the plurality of turbine blades; rotating gearing of a transmission via rotation of the turbine shaft; driving rotation of a fuel-pump drive shaft and an oxidizer-pump drive shaft operatively interconnected with the ring gear via the gearing of the transmission to actuate a fuel pump and an oxidizer pump, respectively; pumping a second amount of the fuel from the fuel tank via actuation of the fuel pump into a first cooling circuit and a second cooling circuit, cooling the combustion chamber and the engine nozzle using the first cooling circuit, and cooling the plurality of turbine blades using the second cooling circuit, and further supplying the combustion chamber with the fuel with the second amount of the fuel from the first cooling circuit and the second cooling circuit; and pumping a second amount of the oxidizer from the oxidizer tank via actuation of the oxidizer pump, and further supplying the combustion chamber with the oxidizer.

### BRIEF DESCRIPTION OF DRAWINGS

FIG. 1 is a generalized 2D schematic view of a single combustion outboard turbine rocket engine according to the present disclosure;

FIG. 2 is a generalized 3D schematic view of the rocket engine of FIG. 1;

FIG. 3 is a detailed 2D schematic cross-sectional view of a single combustion outboard turbine rocket engine according to the present disclosure;

FIG. 4 is a cross-section taken along Line 4-4 of FIG. 3;

FIG. 5 is a cross-section taken along Line 5-5 of FIG. 3;

FIG. 6 is a first enlarged view of FIG. 3; and

FIG. 7 is a second enlarged view of FIG. 3.

### DETAILED DESCRIPTION

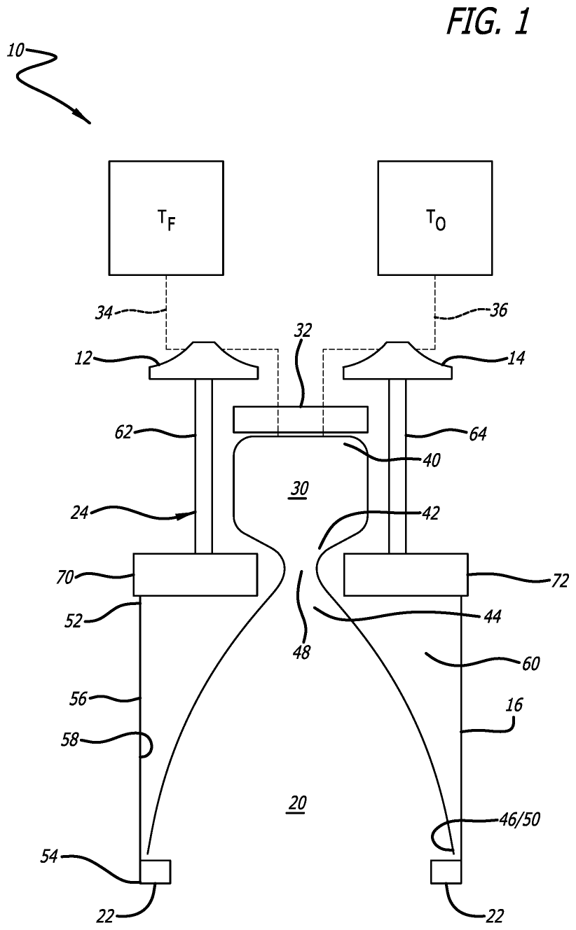

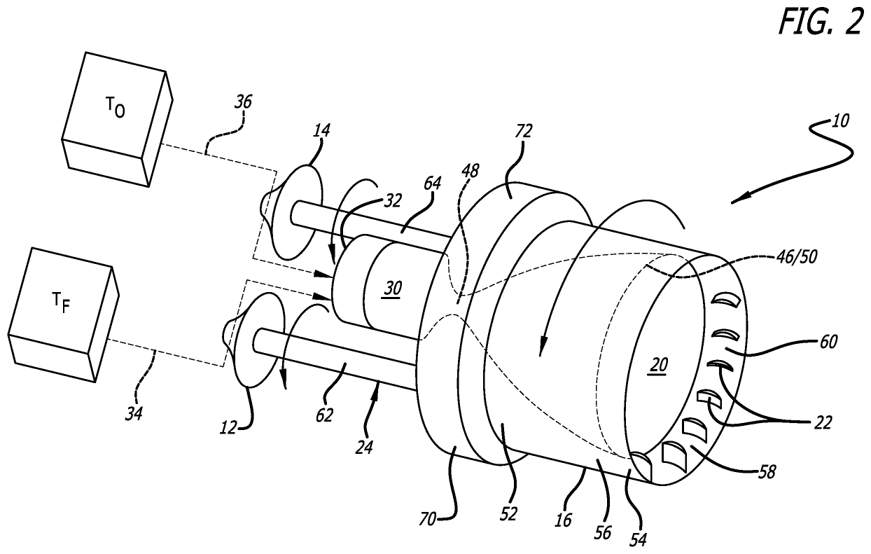

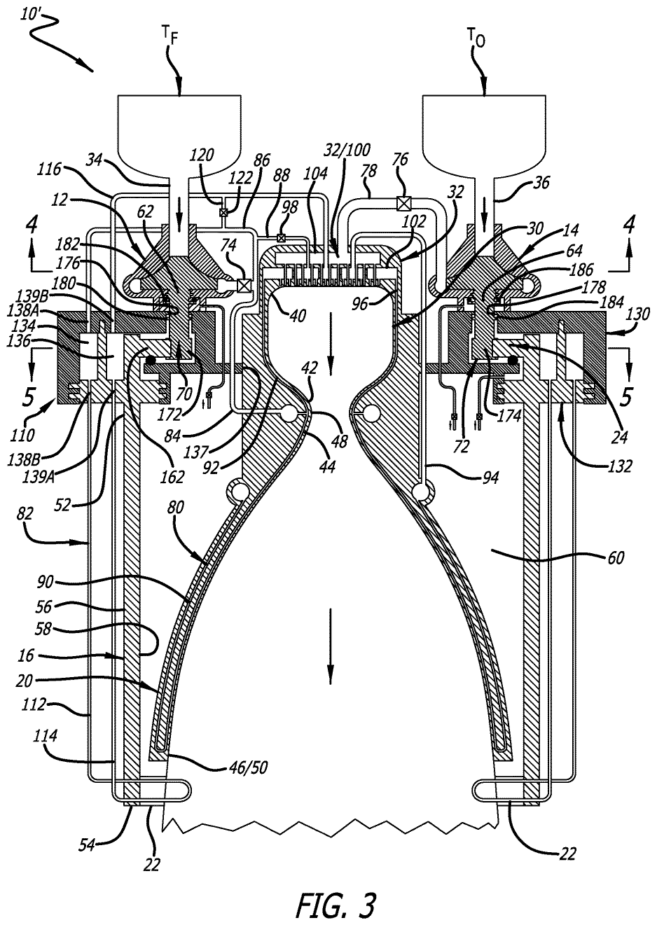

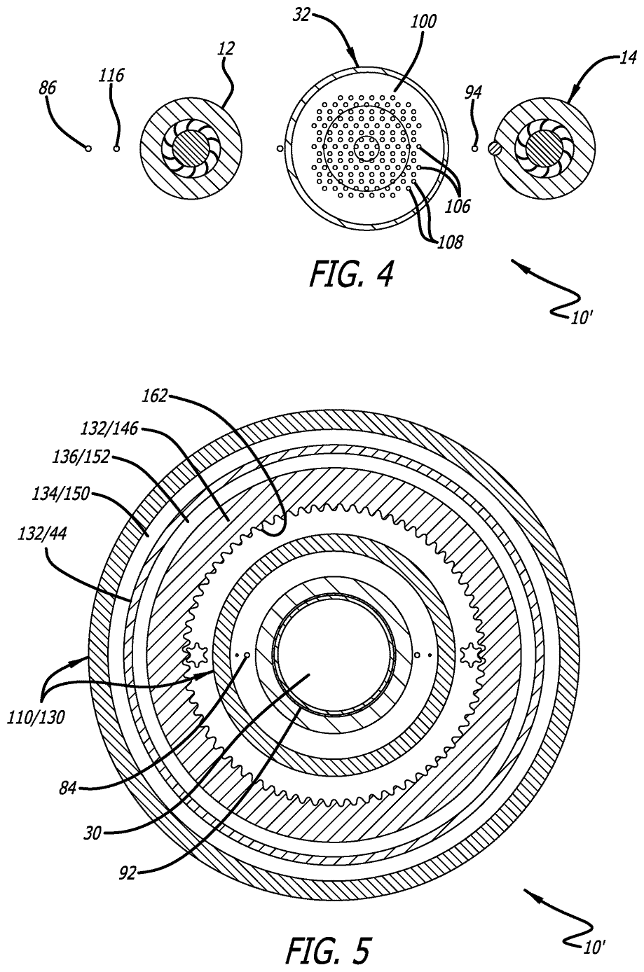

A single combustion outboard turbine rocket engine is generally indicated by the numeral 10 in FIGS. 1 and 2. The rocket engine 10 employs a rocket cycle that is self-sustaining by using exhaust thereof to drive operation of a fuel pump 12 and/or an oxidizer pump 14. FIGS. 1 and 2 are generalized schematic depictions of the engine 10 that generally illustrate a potential configuration thereof. FIGS. 1 and 2 and the description thereof broadly depict and describe operation of the engine 10 that provides grounding for understanding the present disclosure. The features of the engine 10 are also embodied in an engine generally indicated by the number 10′ in FIGS. 3-5, and FIGS. 3-5 and the description thereof specifically depict and detail a more complicated configuration of a single combustion outboard turbine engine of the present disclosure. In addition to including the features of the engine 10, the engine 10′ is configured for modulation of flow of fuel and oxidizer, and includes various cooling circuits for correspondingly cooling portions of the engine 10′. The engine 10 and the engine 10′ use a single combustion outboard turbine rocket cycle, and the rocket cycle serves in simplifying the engines 10 and 10′ in certain respects in comparison to staged combustion cycle engines.

The engine 10 is configured to drive operation of the fuel pump 12 and the oxidizer pump 14 using exhaust of the engine 10 itself. As discussed below, the engine 10 includes a turbine shaft 16 that can surround all or portions of an engine nozzle 20, and the turbine shaft 16 includes various supersonic turbine blades 22 circumferentially spaced therearound and positioned downstream of the nozzle 20. The exhaust expelled from the engine nozzle 20 comes into contact with and passes over the turbine blades 22, and the interaction of the exhaust with the turbine blades 22 serves in driving rotation of the turbine shaft 16.

The turbine shaft 16, as depicted in FIGS. 1 and 2, is operatively interconnected by a transmission 24 to the fuel pump 12 and the oxidizer pump 14, and rotation of the turbine shaft 16 drives actuation of the fuel pump 12 and the oxidizer pump 14 via the transmission 24. The fuel pump 12 and the oxidizer pump 14 are driven by the turbine shaft 16 to provide a supply of fuel and oxidizer from a fuel tank T_{F} and an oxidizer tank T_{O}, respectively, to the engine 10. To illustrate, by using the exhaust of the engine nozzle 20, the rocket engine 10 and the rocket cycle can remove the need for one or more pre-burners and piping necessary to deliver exhaust from the one or more of pre-burners to turbines for driving the fuel pump 12 and/or the oxidizer pump 14.

The engine 10, as depicted in FIGS. 1 and 2, includes a combustion chamber 30 and an injector 32 upstream of the combustion chamber 30 that is fed by a fuel supply line 34 and an oxidizer supply line 36. The combustion chamber 30 is positioned upstream of the engine nozzle 20, and combustion chamber 30 can be formed integrally with the engine nozzle 20, or can be formed separately and then attached to the engine nozzle 20. Furthermore, the fuel supply line 34 is fed by the fuel tank T_{F} and the oxidizer supply line 36 is fed by the oxidizer tank T_{O}. The injector 32 injects the fuel from the fuel supply line 34 and the oxidizer from the oxidizer supply line 36 into the combustion chamber 30. And the reaction between fuel from the fuel supply line 34 and oxidizer from the oxidizer supply line 36 in the combustion chamber 30 combusts and produces the exhaust that is directed into and out of the engine nozzle 20 from the combustion chamber 30.

As depicted in FIGS. 1 and 2, the combustion chamber 30 includes a proximal end 40 and a distal end 42, and the engine nozzle 20 includes a proximal end 44 and a distal end 46. Additionally, a throat 48 is positioned between the combustion chamber 30 and the engine nozzle 20 at and adjacent the distal end 42 of the combustion chamber 30 and the proximal end 44 of the engine nozzle 20, and after combustion of the fuel and the oxidizer in the combustion chamber 30, the exhaust exits the distal end 42 of the combustion chamber 30 and enters the proximal end 44 of the engine nozzle 20 through the throat 48. The exhaust then ultimately exits the engine nozzle 20 from an exit aperture 50 at the distal end 46 to generate thrust provided by the engine 10.

The turbine shaft 16, as depicted in FIGS. 1 and 2, surrounds all or portions of the engine nozzle 20. More specifically, the turbine shaft 16 is rotatable around the portions of the engine nozzle 20 and the combustion chamber 30. The turbine shaft 16, as depicted in FIG. 2, can be cylindrical, and includes a proximal end 52, a distal end 54, and an exterior surface 56 and an interior surface 58 extending between the proximal end 52 and the distal end 54. The interior surface 58 defines in part an interior cavity 60 in which all or portions of the engine nozzle 20 are received. The turbine blades 22 are circumferentially spaced around the interior surface 58 in the interior cavity 60 adjacent the distal end 54 of the turbine shaft 16.

While FIGS. 1 and 2 show a single row of the turbine blades 22 circumferentially spaced around the interior surface 58, the present disclosure is not so limited. Multiple rows of the turbine blades 22 can be provided on the interior surface 58 downstream of the exit aperture 50. The turbine blades 22 are positioned to facilitate interaction thereof with the exhaust exiting the exit aperture 50. As discussed below, the configuration of the turbine blades 22 and positions thereof interact with the exhaust, and the interaction causes the turbine shaft 16 to rotate. The turbine blades 22 can each be configured as an airfoil having a leading edge, a trailing edge, and a convex vacuum side a concave pressure side extending between the leading edge and the trailing edge. The turbine blades 22 are oriented similarly to facilitate pressure differentials between the convex vacuum sides and the concave pressure sides thereof due to interaction with the exhaust that forces rotation of the turbine shaft 16.

The rotation of the turbine shaft 16 drives the transmission 24, and the transmission 24 ultimately drives the fuel pump 12 and the oxidizer pump 14. As depicted in FIGS. 1 and 2, the transmission 24 can include one or more gearboxes, a fuel-pump input shaft (or fuel-pump drive shaft) 62, and an oxidizer-pump input shaft (oxidizer-pump drive shaft) 64. In some embodiments, the use of the turbine shaft 16 can eliminate the need for one or more pre-burners to drive operation of the fuel pump 12 and the oxidizer pump 14. In other embodiments, one or more pre-burners can be used to supplement driving of the fuel pump 12 and the oxidizer pump 14 via the rotation of the turbine shaft 16.

Furthermore, as depicted in FIGS. 1 and 2, the transmission 24 includes a first gearbox portion 70 including gearing for driving the fuel-pump input shaft 62 due to rotation of the turbine shaft 16, and a second gearbox portion 72 including gearing for driving the oxidizer-pump input shaft 64 due to rotation of the turbine shaft 16. The first gearbox portion 70 and the second gearbox portion 72 can each be operatively interconnected with and driven by rotation of the turbine shaft 16, and the fuel-pump input shaft 62 and the oxidizer-pump input shaft 64 can each be operatively interconnected with and driven by the first gearbox portion 70 and the second gearbox portion 72, respectively. The fuel pump 12 and the oxidizer pump 14 can then be driven by the fuel-pump input shaft 62 and the oxidizer-pump input shaft 64, respectively. Additional gearing, gearboxes, and/or shafts can be interposed between the first gearbox portion 70 and the second gearbox portion 72, and the fuel-pump input shaft 62 and the oxidizer-pump input shaft 64, respectively, and/or between the fuel-pump input shaft 62 and the oxidizer-pump input shaft 64, and the fuel pump 12 and the oxidizer pump 14, respectively to drive the fuel pump 12 and the oxidizer pump 14. The actuation of the fuel pump 12 and the oxidizer pump 14 is used to respectively deliver fuel from the fuel tank T_{F} via the fuel supply line 34 and oxidizer from the oxidizer tank T_{O} via the oxidizer supply line 36 to feed the injector 32 and then the combustion chamber 30.

The first gearbox portion 70 and the second gearbox portion 72 can each include one or more reducer gears, multiplier gears, and/or idler gears, and can each include multiple output speeds that drive rotation of the fuel-pump input shaft 62 and the oxidizer-pump input shaft 64 to correspondingly drive the fuel pump 12 and the oxidizer pump 14. The multiple output speeds of the first gearbox portion 70 and the second gearbox portion 72 can be controlled, for example, by one or more computer controllers (not shown), and the one or more computer controllers can be used to select suitable speeds from the multiple output speeds to drive the fuel pump 12 and the oxidizer pump 14 at desired speeds to supply the injector 32 upstream of the combustion chamber 30 to operate the engine 10.

Like the engine 10, the engine 10′, as depicted in FIG. 3, also includes the fuel pump 12, the oxidizer pump 14, the turbine shaft 16, the fuel tank T_{F}, the oxidizer tank T_{O}, the engine nozzle 20, the turbine blades 22, the transmission 24, the combustion chamber 30, the injector 32, the fuel supply line 34, the oxidizer supply line 36, the throat 48, the fuel-pump input shaft 62, the oxidizer-pump input shaft 64, the first gearbox portion 70, the second gearbox portion 72, and the features thereof. And like the engine 10, the engine 10′ employs a rocket cycle that is self-sustaining by using exhaust thereof to drive operation of the fuel pump 12 and/or the oxidizer pump. Additionally, as depicted in FIG. 3, the engine 10′ includes a fuel valve 74 (downstream of the fuel pump 12) and an oxidizer valve 76 interrupting an oxidizer-supply branch 78 (downstream of the oxidizer pump 14) to aid in modulation of flow of the fuel and the oxidizer supplied from the fuel tank T_{F} and the oxidizer tank T_{O}, respectively. And to manage heat generated by the exhaust, the engine 10′ also includes a first cooling system 80 and a second cooling system 82.

The first cooling system 80 is a first cooling circuit used in cooling the engine nozzle 20 and the combustion chamber 30, and the second cooling system 82 is a second cooling circuit used in cooling the turbine blades 22. FIG. 3 depicts configurations of cooling lines for the first cooling system 80 and the second cooling system 82. Coolant used for cooling the engine nozzle 20 and the combustion chamber 30 (by the first cooling system 80), and the turbine blades 22 (by the second cooling system 82) is the fuel supplied to the fuel pump 12 by the fuel supply line 34 from the fuel tank T_{F}.

Operation of the fuel pump 12 ultimately supplies the injector 32 with the fuel supplied from the fuel tank T_{F}. A first portion of the fuel from the fuel pump 12 can be directed to the first cooling system 80 via a first fuel-line branch 84 and then ultimately to the injector 32, a second portion of the fuel from the fuel pump 12 can be directed to the second cooling system 82 via a second fuel-line branch 86 and then ultimately to the injector 32, and a third portion of the fuel from the fuel pump 12 can be directly provided to the injector 32 via a first injector-supply branch 88 that extends from the first fuel-line branch 84 to the injector 32. Before entering either the first cooling system 80, the second cooling system 82, or the first injector-supply branch 88, the fuel valve 74 interrupts and can correspondingly modulate the flow of the fuel into the first fuel-line branch 84, the second fuel-line branch 86, and the first injector-supply branch 88 to control flow of the fuel therethrough.

The first fuel-line branch 84 feeds the first cooling system 80 by feeding one or more sub-branches 90 and 92. As depicted in FIG. 3, the sub-branches 90 can extend around, along, and/or through portions of the engine nozzle 20, and the sub-branches 92 can extend around, along, and/or through portions of the combustion chamber 30. Some of the sub-branches 90 and 92, for example, can have toroidal shapes of different sizes spaced along and surrounding various portions of the engine nozzle 20 or the combustion chamber 30, and some of the sub-branches 90 and 92 can follow exterior shapes of the engine nozzle 20 or the combustion chamber 30, and be connected the sub-branches 90 and 92 having toroidal shapes.

As depicted in FIG. 3, the sub-branches 90 are directed along and around the engine nozzle 20, and then converge back to feed one or more second injector-supply branches 94 that extends to and feed the injector 32. After the fuel passes into the first fuel-line branch 84, and through the sub-branches 90 to cool the engine nozzle 20, the fuel is delivered to the injector 32 for injection into the combustion chamber 30 by the second injector-supply branch(es) 94. Furthermore, as depicted in FIG. 3, the sub-branches 92 are directed along and around the combustion chamber 30, and then become (with or without convergence thereof) one or more third injector-supply branches 96. After the fuel passes into the fuel-line branch 84, and the through the sub-branches 92 to cool the combustion chamber 30, the fuel is delivered to the injector 32 for injection into the combustion chamber 30 by the third injector-supply branch(es) 96.

Additionally, the first injector-supply branch 88 is interrupted by a nozzle-cooling control valve 98, and the nozzle-cooling control valve 98 can be used to modulate (in addition to the fuel valve 74) the flow of fuel into the first cooling system 80. When the nozzle-cooling control valve 98 is closed, the flow of the fuel is directed to the first fuel-line branch 84 (and to the first cooling system 80) and the second fuel-line branch 86 (and to the second cooling system 82). When the nozzle-cooling control valve 98 is opened or partially opened, the flow of the fuel can be directed to the injector 32 via the first injector-supply branch 88, rather than the first cooling system 80 or the second cooling system 82. The amount of the flow of the fuel directed through the first injector-supply branch 88 via the nozzle-cooling control valve 98 would depend on how far the nozzle-cooling control valve 98 is opened. As such, the nozzle-cooling control valve 98 (along with the fuel valve 74) can modulate the flow of the fuel pumped into the first fuel-line branch 84 and the second fuel-line branch 86 by the fuel pump 12 (and into the first cooling system 80 and the second cooling system 82, respectively) by affecting the amount of the fuel fed to the injector 32 (and the combustion chamber 30) via the first injector-supply branch 88.

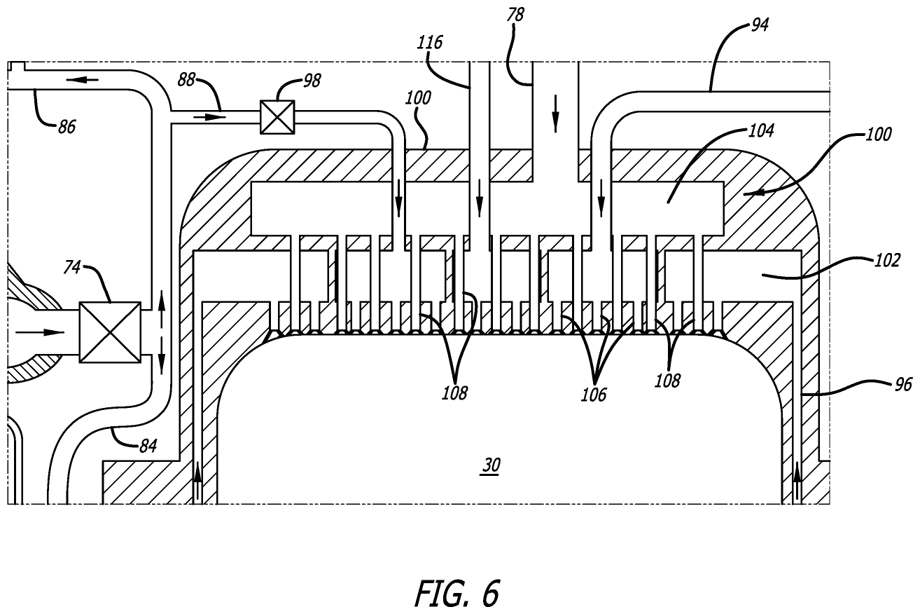

The injector 32, as depicted in FIGS. 3 and 6, includes an injector manifold 100 positioned upstream of the combustion chamber 30. The injector manifold 100 can be formed integrally with the combustion chamber 30, or can be formed separately and then attached to the combustion chamber 30. The injector manifold 100 is configured for injecting the fuel from the fuel tank T_{F} and the oxidizer tank T_{O} after the injector 32 is supplied therewith. To that end, as depicted in FIG. 6, the injector 32 includes a fuel reservoir 102 and an oxidizer reservoir 104. The fuel reservoir 102, as depicted in FIG. 6, is supplied with the fuel via the first injector-supply branch 88, the second injector-supply branch(es) 94, the third injector-supply branch(es) 96, and an injector-supply branch from the second cooling system 82, and the oxidizer reservoir 104 is supplied with oxidizer via the oxidizer-supply branch 78 from the oxidizer pump 14. After receipt of the fuel in the fuel reservoir 102, the fuel is supplied to the combustion chamber 30 via a plurality of fuel injection ports 106, and after receipt of the oxidizer in the oxidizer reservoir 104, the oxidizer is supplied to the combustion chamber 30 via a plurality of oxidizer injection ports 108.

As depicted in FIG. 3, the second fuel-line branch 86 feeds the second cooling system 82 by feeding a cooling manifold 110. The cooling manifold 110 is used in at least facilitating (1) rotation of the turbine shaft 16, (2) cooling of the turbine blades 22 by supplying the turbine blades 22 with the fuel via one or more sub-branches 112, (3) receiving the fuel returned from the turbine blades 22 via one or more sub-branches 114, and (4) feeding the injector 32 with the fuel returned from the turbine blades 22. Pairs of the sub-branches 112 and 114 can be circumferentially spaced around the exterior of the turbine shaft 16, and each pair of the sub-branches 112 and 114 can be used to facilitate cooling of one of the turbine blades 22. As depicted in FIG. 3, the sub-branches 112 extend from the cooling manifold 110 and into the turbine blades 22, and the sub-branches 114 extend out of the turbine blades 22 and back to the cooling manifold 110. The flow of the fuel through the sub-branches serves in cooling the turbine blades 22, and the flow of the fuel through the sub-branches 114 returns the fuel to the cooling manifold 110. After returning to the cooling manifold 110, the fuel is directed through a fourth injector-supply branch 116 extending from the cooling manifold 110 to the injector 32 to feed the combustion chamber 30.

Additionally, as depicted in FIG. 3, a connecting branch 120 extends between the second fuel-line branch 86 and the fourth injector-supply branch 116. The connecting branch 120 is interrupted by a turbine-cooling control valve 122, and the turbine-cooling control valve 122 can be used to modulate (in addition to the fuel valve 74) the flow of fuel in the second cooling system 82. When the turbine-cooling control valve 122 is closed, the flow of fuel is directed into the second fuel-line branch 86 to the second cooling system 82. When the turbine-cooling control valve 122 is opened or partially opened, the flow of fuel can be directed to the injector via the fourth injector-supply branch 116, rather than to the second cooling system 82. The amount of the flow of the fuel directed through the connecting branch 120 would depend on how far the turbine-cooling control valve 122 is opened. As such, the turbine-cooling control valve 122 (along with the fuel valve 74) can modulate the flow of the fuel pumped into the second fuel-line branch 92 to the second cooling system 82 by affecting the amount of the fuel fed to the injector 32 (and the combustion chamber 30) via the connecting branch 120 and the fourth injector-supply branch 116.

As discussed above, the cooling manifold 110 facilitates rotation of the turbine shaft 16, cooling of the turbine blades 22 by supplying the turbine blades 22 with the fuel via the sub-branch(es) 112, and receiving of the fuel returned from the turbine blades 22 via the sub-branch(es) 114. To that end, the cooling manifold 110 includes a body portion 130 and a flange portion 132 rotatably supported by the body portion 130, which together, as depicted in FIG. 3, form an inlet reservoir 134 and an outlet reservoir 136 in the cooling manifold 110. As depicted in FIG. 5, the inlet reservoir 134 and the outlet reservoir 136 can be annular shaped. Furthermore, the body portion 130 can be at least in part annular shaped with a center aperture 137, as shown in FIG. 3, and the center aperture 137 can be sized to receive portions of the engine nozzle 20 and/or the combustion chamber 30 therethrough.

In addition to being rotatably attached to the cooling manifold 110, and partially forming the inlet reservoir 134 and the outlet reservoir 136, the flange portion 132, as depicted in FIG. 3, can be attached to an upper portion of the turbine shaft 16, and serves in rotatably connecting the turbine shaft 16 to the cooling manifold 110. Because the body portion 130 is configured to surround the portions of the engine nozzle 20 and/or the combustion chamber 30, the flange portion 132 is rotatable relative to the body portion 130, and the turbine shaft 16 is attached to the flange portion 132, the turbine shaft 16, as discussed above, is rotatable around the engine nozzle 20 and the combustion chamber 30.

As discussed below, the flange portion 132 is configured to rotate with respect to the body portion 130 via rotation of the turbine shaft 16, while simultaneously (1) affording ingress of the fuel from the second fuel-line supply branch 92 to the inlet reservoir 134 and then egress of the fuel from the inlet reservoir 134 to the sub-branch(es) 112, and (2) affording ingress of the fuel from the sub-branch(es) 114 to the outlet reservoir 136 and then egress of the fuel from the outlet reservoir 136 to the fourth injector-supply branch 116 to supply the injector 32 and then the combustion chamber 30. And even during rotation of the flange portion 132 relative to the body portion 130, the body portion 130 and the flange portion 132 are configured to facilitate maintaining of the fluid-tight integrity of the inlet reservoir 134, and between the inlet reservoir 134 and the outlet reservoir 136.

To illustrate, the inlet reservoir 134, even when the flange portion 132 is rotating relative to the body portion 130 of the cooling manifold 110, is supplied with the fuel from the second fuel-line branch 92, and the inlet reservoir 134 supplies the sub-branches 112 with the fuel to cool the turbine blades 22. To that end, as depicted in FIG. 3, the body portion 130 includes an ingress port 138A communicating with the second fuel-line branch 86 and the inlet reservoir 134, and the flange portion 132 includes various egress ports 138B each communicating with the inlet reservoir 134 and the sub-branches 112. The sub-branches 112, as discussed above, are spaced around the exterior of the turbine shaft 16, and the egress ports 138B are similarly spaced to afford communication with the sub-branches 112. As such, the configuration of the body portion 130 and the flange portion 132 afford fluid communication between the second fuel-line branch 86, the inlet reservoir 134, and the sub-branches 112 during operation of the engine 10′ and the corresponding rotation of the flange portion 132 (and the turbine shaft 16) relative to the body portion 130.

Furthermore, the outlet reservoir 136, even when the flange portion 132 is rotating relative to the body portion 130 of the cooling manifold 110, is supplied with the fuel from the sub-branches 114 after cooling the turbine blades 22, and the outlet reservoir 136 supplies the injector 32 and then the combustion chamber 30 via the fourth injector-supply branch 116. To that end, as depicted in FIG. 3, the body portion 130 includes various ingress ports 139A each communicating with the sub-branches 114 and the outlet reservoir 136, and an egress port 139B communicating with the outlet reservoir 136 and the fourth injector-supply branch 116. Like the sub-branches 112, the sub-branches 114, as discussed above, are spaced around the exterior of the turbine shaft 16, and the ingress ports 139A are similarly spaced to afford communication with the sub-branches 114. As such the configuration of the body portion 130 and the flange portion 132 afford fluid communication between the sub-branches 114, the outlet reservoir 136, and the fourth injector-supply branch 116 during operation of the engine 10′ and the corresponding rotation of the flange portion 132 (and the turbine shaft 16) relative to the body portion 130.

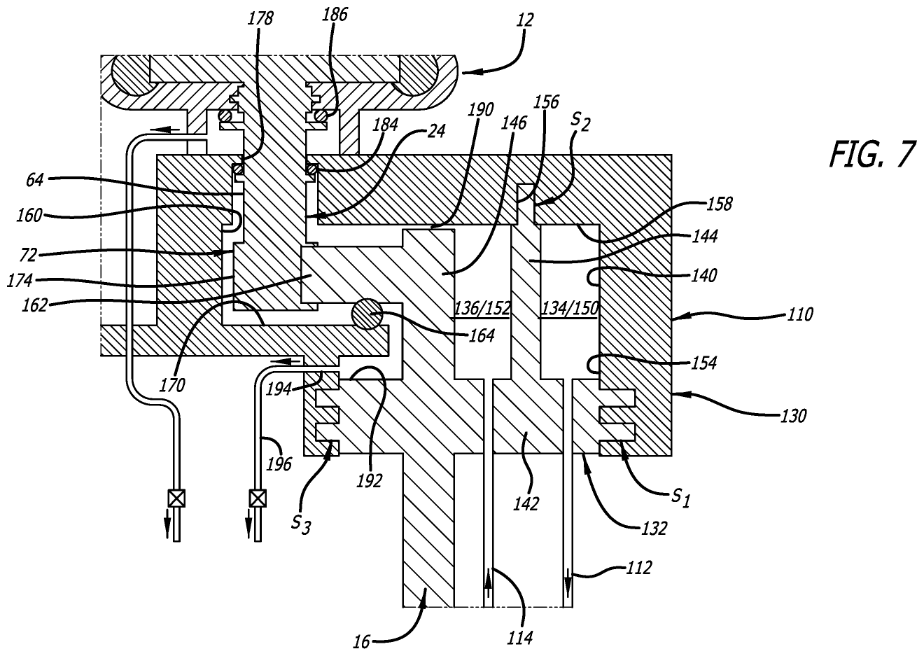

The body portion 130, as depicted in FIG. 7, can be configured to include a first interior recess portion 140 for receiving portions of the flange portion 132. The first interior recess portion 140 can have an annular shape configured to accommodate rotation of the portions of the flange portion 132 therein, while also forming the inlet reservoir 134 and the outlet reservoir 136. The first interior recess portion 140 together with portions of the flange portion 132 forms portions of both the inlet reservoir 134 and the outlet reservoir 136. For example, as depicted in FIG. 7, the flange portion 132 can include a base portion 142, a first wall portion 144, and a second wall portion 146. The first wall portion 144 and the second wall portion 146 extend upwardly from the base portion 142, and can have annular shapes with the second wall portion 146 being positioned inside of the first wall portion 144. The first wall portion 144 and the second wall portion 146 are configured for receipt in the first interior recess portion 140 of the body portion 130.

As depicted in FIG. 7, when the first wall portion 144 and the second wall portion 146 are received in the first interior recess portion 140, the base portion 142, the first wall portion 144, and portions of the first interior recess portion 140 form a first channel 150, and the base portion 142, the first wall portion 144, the second wall portion 146, and portions of the first interior recess portion 140 form a second channel 152. The first channel 150 and the second channel 152 form all or portions of the inlet reservoir 134 and the outlet reservoir 136, respectively, and even as the flange portion 132 rotates relative to the body portion 130, the fluid-tight integrity of the inlet reservoir 134, and between the inlet reservoir 134 and the outlet reservoir 136 is maintained.

To maintain the fluid-tight integrity of the inlet reservoir 134, as depicted in FIG. 7, the flange portion 132 forms a first seal S₁ with a portion of the body portion 130, and the first wall portion 144 forms a second seal S₂ with another portion of the body portion 130. To illustrate, the first seal S₁ can be formed on the flange portion 132 to interface with a first recess wall portion 154 of the first interior recess portion 140 to prevent leakage therearound. Additionally, the second seal S₂ can be formed on a portion of the first wall portion 144 received in a groove 156 formed in a second recess wall portion 158 of the first interior recess portion 140. By preventing leakage of the fuel around the first seal S₁ and the second seal S₂, the fluid-tight integrity is maintained in the inlet reservoir 134 even during rotation of the flange portion 132 relative to the body portion 130, while simultaneously permitting the flow of the fuel through the inlet reservoir 134 from the second fuel-line branch 86 to the sub-branches 112. Furthermore, by preventing the leakage of the fuel around the second seal S₂, the fluid-tight integrity is maintained between the inlet reservoir 134 and the outlet reservoir 136 even during rotation of the flange portion 132 relative to the body portion 130, while simultaneously permitting the flow of the fuel through outlet reservoir 136 from the sub-branches 114 to the fourth injector-supply branch 116. The seals S₁ and/or S₂, for example, can be labyrinth seals that aid in preventing escape of the fuel from the cooling manifold 110.

Additionally, the body portion 130, as depicted in FIG. 7 can be configured to contain portions of the transmission 24 (including the first gearbox portion 70 and the second gearbox portion 72) that ultimately drives rotation of the fuel pump 12 and the oxidizer pump 14, respectively, and to facilitate cooling of the transmission 24 using the fuel supplied thereto. To that end, as depicted in FIG. 7, the body portion 130 includes a second recess portion 160 configured to receive the portions of the transmission 24 and portions of the flange portion 132. The transmission 24 includes a ring gear 162 provided on the flange portion 132 that extends into the second recess portion 160 from the second wall portion 146, and the ring gear 162 is configured to operatively engage the first gearbox portion 70 and the second gearbox portion 72. Furthermore, the cooling manifold 110 can include a flange bearing 164 provided in the second recess portion 160 to support the rotation of the flange portion 132 relative to the body portion 130. The flange bearing 164 is positioned between the ring gear 162 and a third recess wall portion 170 to allow the flange portion 132 (and the ring gear 162) to rotate relative to the body portion 130 (in the first interior recess portion 140 and the second recess portion 160). As discussed below, rotation of the ring gear 162 drives the first gearbox portion 70 and the second gearbox portion 72.

The first gearbox portion 70 includes a first gear 172 (FIG. 3) facilitating rotation of the fuel-pump input shaft 62, and the second gearbox portion 72 includes a second gear 174 (FIGS. 3 and 7) facilitating rotation of the oxidizer-pump input shaft 64. The ring gear 162 is operatively interconnected with the first gear 172 and the second gear 174, and rotation of the ring gear 162 (via the rotation of the turbine shaft 16 and the flange portion 132) drives corresponding rotation of the first gear 172 and the second gear 174 to drive the first gearbox portion 70 and the second gearbox portion 72, respectively. As depicted in FIG. 3, the fuel pump 12 and the oxidizer pump 14 can each be attached to the cooling manifold 110. And the fuel-pump input shaft 62 can extend out of the second recess portion 160 via a first shaft opening 176 to drive the fuel pump 12, and the oxidizer-pump input shaft 64 can extend out of the second recess portion 160 via a second shaft opening 178 to drive the oxidizer pump 14. The fuel-pump input shaft 62 and the oxidizer-pump input shaft 64, as depicted in FIG. 3, can be positioned on opposite sides of the body portion 130 in positions that correspond to the locations of the fuel pump 12 and the oxidizer pump 14. As such, rotation of the ring gear 162 rotates both the first gear 172 and the second gear 174 that correspondingly rotates the fuel-pump input shaft 62 and the oxidizer-pump input shaft 64 to drive the fuel pump 12 and the oxidizer pump 14, respectively.

The rotation of the fuel-pump input shaft 62 is facilitated by a first shaft bearing 180 of the transmission 24 provided adjacent the first shaft opening 176, and a second shaft bearing 182 provided in the fuel pump 12. Furthermore, the rotation of the oxidizer-pump input shaft 64 is facilitated by a third shaft bearing 184 of the transmission 24 provided adjacent the second shaft opening 178, and a fourth shaft bearing 186 provided in the oxidizer pump 14. And while, as depicted in FIG. 3, a direct interconnection of the ring gear 162 with the first gear 172 and the second gear 174 can be used in the first gearbox portion 70 and the second gearbox portion 72, additional gearing such as reducing, multiplying, and/or idler gears can be interposed therebetween, and while the first gear 172 and the second gear 174 can be attached directly to the fuel-pump input shaft 62 and the oxidizer-pump input shaft 64, additional gearing such as reducing, multiplying, and/or idler gears can also be interposed therebetween. Furthermore, while only one of each of the fuel-pump shaft 62 and the oxidizer-pump shaft 64 can be used, additional shafts and gearing can be provided to facilitate driving of the fuel pump 12 and the oxidizer pump 14 using the rotation of the ring gear 162 (via the rotation of the turbine shaft 16 and the flange portion 132), and additional bearings can be provided as necessary to support rotation of such additional shafts. Conversely, a single shaft also can be provided to drive operation of the fuel pump 12 and the oxidizer pump 14. Use of a single shaft could simplify configurations of the cooling manifold 110 by requiring only one shaft opening in the body portion 130 and only one set of bearings for rotatably supporting the single shaft relative to the body portion 130.

In addition to permitting the flow of the fuel therethrough, the outlet reservoir 136, as discussed below, is also configured to permit passage of the fuel to the second recess portion 160 to cool the transmission 24. To illustrate, as depicted in FIG. 7, a gap 190 is formed between the second wall portion 146 and the second recess wall portion 158, and the fuel can pass from the outlet reservoir 136 to the second recess portion 160 via the gap 190. The fuel passed to the second recess portion 160 cools the ring gear 162, the portions of the first gearbox portion 70 and the second gearbox portion 72 (including the first gear 172, the second gear 174, and other (if any) gears interposed therebetween, and also cools the flange bearing 164, the first shaft bearing 180, the third shaft bearing 184, and other (if any) bearings provided therein. Thereafter, the flow of the fuel can pass by the flange bearing 164 to facilitate discharge thereof from the second recess portion 160. To illustrate, as depicted in FIG. 7, after passing by the flange bearing 164, the fuel used in cooling the transmission 24 and the flange bearing 164 can exit the second recess portion 160 via a discharge recess portion 192 of the body portion 130, a discharge port 194 formed in the body portion 130, and a discharge line 196 extending outwardly from the discharge portion 194. A third seal S₃, as depicted in FIG. 7, is provided between a portion of the body portion 130 and the flange portion 132 to force the fuel to exit the discharge recess portion 192 via the discharge port 194 and the discharge line 196. Like the seals S₁ and/or S₂, the seal S₃, for example, can be a labyrinth seal that aids in preventing escape of the fuel from the cooling manifold 110.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (for example, all described acts or events may not be necessary to carry out the techniques). In addition, while certain aspects of this disclosure are described as being performed by a single module or unit for purposes of clarity, it should be understood that the techniques of this disclosure may be performed by a combination of units or modules.

I claim:

1. A method of operating a single combustion outboard turbine rocket engine, the method comprising:
supplying a combustion chamber with a first amount of fuel from a fuel tank and a first amount of oxidizer from an oxidizer tank;
combusting the first amount of the fuel and the first amount of the oxidizer in the combustion chamber to generate exhaust;
expelling the exhaust from the combustion chamber and into an engine nozzle;
expelling the exhaust from the engine nozzle via an exit aperture;
contacting the exhaust expelled from the engine nozzle with a plurality of turbine blades provided on a turbine shaft downstream of the exit aperture;
driving rotation of the turbine shaft via interactions of the exhaust with the plurality of turbine blades
actuating a fuel pump and an oxidizer pump via a transmission driven by the rotation of the turbine shaft;
pumping a second amount of the fuel from the fuel tank via actuation of the fuel pump, and further supplying the combustion chamber with the second amount of the fuel; and
pumping a second amount of the oxidizer from the oxidizer tank via actuation of the oxidizer pump, and further supplying the combustion chamber with the second amount of the oxidizer.

2. The method of claim 1, further comprising expelling the exhaust from the combustion chamber via a throat positioned between the combustion chamber and the engine nozzle, and the turbine shaft is rotatable about portions of the throat.

3. The method of claim 1, wherein the turbine shaft is rotatable around at least portions of at least one of the combustion chamber and the engine nozzle, and the transmission is positioned upstream of the engine nozzle.

4. The method of claim 1, further comprising:
rotating a ring gear of the transmission via rotation of the turbine shaft;
rotating a fuel-pump drive shaft via the rotating of the ring gear; and
rotating an oxidizer-pump drive shaft via the rotating of the ring gear;
wherein rotation of the fuel-pump drive shaft and the oxidizer-pump drive shaft actuates the fuel pump and the oxidizer pump, respectively.

5. The method of claim 4, wherein at least a first gear of the transmission facilitates driving engagement between the ring gear and the fuel pump-drive shaft, and at least a second gear of the transmission facilitates driving engagement between the ring gear and the oxidizer-pump drive shaft.

6. The method of claim 1, further comprising, before the further supplying of the combustion chamber with the second amount of the fuel from the fuel tank, directing the second amount of the fuel to both a first cooling circuit for cooling portions of the combustion chamber and the engine nozzle before entering the combustion chamber, and to a second cooling circuit for cooling each of the plurality of turbine blades.

7. The method of claim 6, further comprising supplying a first portion of the second amount of the fuel from the first cooling circuit to an injector after cooling the portions of the combustion chamber and the engine nozzle; and supplying a second portion of the second amount of the fuel from the second cooling circuit to the injector after cooling the plurality of turbine blades.

8. The method of claim 7, wherein the turbine shaft is rotatably supported by a cooling manifold extending around portions of at least one of the combustion chamber, the engine nozzle, and a throat positioned between the combustion chamber and the engine nozzle.

9. The method of claim 8,
wherein the second cooling circuit extends through portions of the cooling manifold; and
further comprising:
rotating the turbine shaft relative to the cooling manifold, and
supplying the second portion of the second amount of the fuel to an inlet reservoir formed in the cooling manifold; and
during the rotating of the turbine shaft relative to the cooling manifold, simultaneously maintaining a first fluid connection between the inlet reservoir and supply lines extending from the inlet reservoir to the plurality of turbine blades to supply the plurality of turbine blades with the second portion of the second amount of the fuel.

10. The method of claim 9,
further comprising:
during the rotating of the turbine shaft relative to the cooling manifold, simultaneously maintaining a second fluid connection between an outlet reservoir formed in the cooling manifold and return lines extending from the plurality of turbine blades to the outlet reservoir to supply the outlet reservoir with the second portion of the second amount of the fuel; and
supplying the injector with the second portion of the second amount of the fuel from the outlet reservoir.

11. A method of operating a single combustion outboard turbine rocket engine, the method comprising:
supplying a combustion chamber with a first amount of fuel from a fuel tank and a first amount of oxidizer from an oxidizer tank;
combusting the first amount of the fuel and the first amount of the oxidizer in the combustion chamber to generate exhaust;
expelling the exhaust from the combustion chamber and into an engine nozzle;
expelling the exhaust from the engine nozzle via an exit aperture;
contacting the exhaust expelled from the engine nozzle with a plurality of turbine blades provided on a turbine shaft downstream of the exit aperture;
rotatably supporting the turbine shaft relative to the combustion chamber and the engine nozzle;
driving rotation of the turbine shaft via interactions of the exhaust with the plurality of turbine blades;
rotating gearing of a transmission via rotation of the turbine shaft;
driving rotation of a fuel-pump drive shaft and an oxidizer-pump drive shaft operatively interconnected with the ring gear via the gearing of the transmission to actuate a fuel pump and an oxidizer pump, respectively;
pumping a second amount of the fuel from the fuel tank via actuation of the fuel pump, and further supplying the combustion chamber with the second amount of the fuel; and
pumping a second amount of the oxidizer from the oxidizer tank via actuation of the oxidizer pump, and further supplying the combustion chamber with the second amount of the oxidizer.

12. The method of claim 11, wherein at least a first gear of the gearing of the transmission facilitates driving engagement between the ring gear and the fuel-pump drive shaft, and at least a second gear of the gearing of the transmission facilitates driving engagement between the ring gear and the oxidizer-pump drive shaft.

13. The method of claim 11, further comprising, before the further supplying of the combustion chamber with the second amount of the fuel from the fuel tank, directing the second amount of the fuel to both a first cooling circuit for cooling portions of the combustion chamber and the engine nozzle before entering the combustion chamber, and to a second cooling circuit for cooling each of the plurality of turbine blades.

14. The method of claim 13, further comprising supplying a first portion of the second amount of the fuel from the first cooling circuit to an injector after cooling the portions of the combustion chamber and the engine nozzle; and supplying a second portion of the second amount of the fuel from the second cooling circuit to the injector after cooling the plurality of turbine blades.

15. The method of claim 14, wherein the turbine shaft is rotatably supported by a cooling manifold extending around portions of at least one of the combustion chamber, the engine nozzle, and a throat positioned between the combustion chamber and the engine nozzle.

16. The method of claim 15,
wherein the second cooling circuit extends through portions of the cooling manifold; and
further comprising:
rotating the turbine shaft relative to the cooling manifold, and
supplying the second portion of the second amount of the fuel to an inlet reservoir formed in the cooling manifold; and
during the rotating of the turbine shaft relative to the cooling manifold, simultaneously maintaining a first fluid connection between the inlet reservoir and supply lines extending from the inlet reservoir to the plurality of turbine blades to supply the plurality of turbine blades with the second portion of the second amount of the fuel.

17. The method of claim 16,
further comprising:
during the rotating of the turbine shaft relative to the cooling manifold, simultaneously maintaining a second fluid connection between an outlet reservoir formed in the cooling manifold and return lines extending from the plurality of turbine blades to the outlet reservoir to supply the outlet reservoir with the second portion of the second amount of the fuel; and
supplying the injector with the second portion of the second amount of the fuel from the outlet reservoir.

18. A method of operating a single combustion outboard turbine rocket engine, the method comprising:
supplying a combustion chamber with a first amount of fuel from a fuel tank and a first amount of oxidizer from an oxidizer tank;
combusting the first amount of the fuel and the first amount of the oxidizer in the combustion chamber to generate exhaust;
expelling the exhaust from the combustion chamber and into an engine nozzle;
expelling the exhaust from the engine nozzle via an exit aperture;
contacting the exhaust expelled from the engine nozzle with a plurality of turbine blades provided on a turbine shaft downstream of the exist aperture;
rotatably supporting the turbine shaft relative to the combustion chamber and the engine nozzle;
driving rotation of the turbine shaft via interactions of the exhaust with the plurality of turbine blades;
rotating gearing of a transmission via rotation of the turbine shaft;
driving rotation of a fuel-pump drive shaft and an oxidizer-pump drive shaft operatively interconnected with the ring gear via the gearing of the transmission to actuate a fuel pump and an oxidizer pump, respectively;
pumping a second amount of the fuel from the fuel tank via actuation of the fuel pump into a first cooling circuit and a second cooling circuit, cooling the combustion chamber and the engine nozzle using the first cooling circuit, and cooling the plurality of turbine blades using the second cooling circuit, and further supplying the combustion chamber with the second amount of the fuel from the first cooling circuit and the second cooling circuit; and
pumping a second amount of the oxidizer from the oxidizer tank via actuation of the oxidizer pump, and further supplying the combustion chamber with the second amount of the oxidizer.

19. The method of claim 18, wherein the turbine shaft is rotatably supported by a cooling manifold extending around portions of at least one of the combustion chamber, the engine nozzle, and a throat positioned between the combustion chamber and the engine nozzle.

20. The method of claim 19,
wherein the second cooling circuit extends through portions of the cooling manifold; and
further comprising:
rotating the turbine shaft relative to the cooling manifold, and
supplying a portion of the second amount of the fuel to an inlet reservoir formed in the cooling manifold;
during the rotating of the turbine shaft relative to the cooling manifold, simultaneously maintaining a first fluid connection between the inlet reservoir and supply lines extending from the inlet reservoir to the plurality of turbine blades to supply the plurality of turbine blades with the portion of the second amount of the fuel;
during the rotating of the turbine shaft relative to the cooling manifold, simultaneously maintaining a second fluid connection between an outlet reservoir formed in the cooling manifold and return lines extending from the plurality of turbine blades to the outlet reservoir to supply the outlet reservoir with the portion of the second amount of the fuel; and
supplying the injector with the portion of the second amount of the fuel from the outlet reservoir.
